(19) United States
(12) Patent Application Publication
(10) Pub. No.: US 2006/0267752 A1
(43) Pub. Date: Nov. 30, 2006

(54) LED arrow light combination

(76) Inventor: Paul D. Crunk, Taylor, MI (US)

Correspondence Address: Paul Crunk, 12220 WOODCREST BOX 725, TAYLOR, MI, 48180, US

(21) Appl. No.: 11/140,354

(22) Filed: May 28, 2005

(51) Int. Cl. B60Q 1/44

(52) U.S. Cl. 340/479; 340/815.45

(57) ABSTRACT

An LED combination light for vehicle usage that is a combination of running light, turn signal light and can also include combination running light, brake light and turn signal light all contained on one single light housing that can also be used as a running light, turn light and stop light all containing the same color LEDs or with the use of two different colors of LEDs or chips inside the led that can create a changing pattern from running light brake light to arrow light or if the running light is not lit it will then be just an arrow turn signal light. This lamp can be used as a standard running light turn light or a running light brake light turn signal light combination or when the running light and brake light is not used it can be used as a turn light only.

A combination LED light for vehicle usage that is a combination running light, turn signal light and can also include the stop/brake light all contained in one signal light housing that can also be used as a running light, turn light and stop light all containing the same color LEDs or two different colors of LEDs that can create a changing pattern from running light/brake light to a turn arrow. When the running light or brake light is not lit the arrow will then light up ON and OFF as a distinct arrow turn signal light. Also it can be done in reverse technology where the brake or running light modes remains lit and the arrow does not light up providing an outlined arrow look.

### BRIEF SUMMARY OF THE INVENTION

LED lights have been around since 1995 in the trucking market to replace standard incandescent lights, which the LED's have bee proven to use less power and can put out high brightness of light. Now with the use of LEDs the lighting can now be designed to more precisely in shapes and configurations, which before have not been able to be achieved before the use of the led technology. The LEDs can be set up in different patterns and the LEDs can contain more than one chip inside each led, which they can all be placed into one lamp configuration for a tail, turn signal mode or tail stop turn signal modes.

### BRIEF DESCRIPTION OF THE DRAWINGS

FIG. 1 shows a led lamp 1 with LEDs 2 that are shown in black circles that are used for running light and brake light, high and low modes.

FIG. 2 shows a led lamp 1 with LEDs 4 in the white circles in the off mode when led 3 are lit up in the ON mode, the turn mode, which will prevent wash out of the arrow shape.

FIG. 2 also shows a led lamp 1 with LEDs 4 in the white circles and LEDs 3 in the black circles to make full LED lamp. When LEDs 4 white circle are on running light or brake light mode they are red in the low or high modes. When LEDs black circles are in the turn signal mode they can change from red low or high mode to red or amber LEDs turn signal mode high mode and at that time led 4 white circles that are red in the low or high mode will cancel and turn OFF, so the red or amber LEDs 3 can be easily seen in turn mode without any washout or colors mix.

FIG. 3 and 4 shows a led lamp 1 with LEDs 4 and 3, which are used for running and stop modes. The LEDs 3 in the white circles are used for the turn signal mode and can be in the OFF to produce a outline turn signal with LEDs 4 around it. When LEDs 3 are turn off the LEDs 4 are in the ON mode, low mode running light or high mode brake light mode, so the arrow can be seen as an outlined arrow of light. The same light can also be where led 4 and 3 are in low or high mode then when LEDs 4 go off the LEDs 3 switch into the high turn signal mode in the color of red or amber to be easily seen without any wash out in colors or color mix.

FIG. 5 shows a led lamp 1 with LEDs 4 and 3, which are used for running and stop modes. The LEDs 3 in the white circles are used for the turn signal mode in the ON mode, the high mode as turn signal, placing LEDs 4 in the switch OFF mode, so the arrow can be seen easily without any wash out. Also it can be done when white circles led 3 turn signal is on the off mode the LEDs 4 black circles will be in the ON mode, so the arrow is seen as an outlined arrow of light. The same light can also be where led 3 and 4 are in low or high mode and when LEDs 4 black circles go off and led 3 white circles that are in low or high mode can be then be turn ON in high mode in the color of red or amber for the turn signal mode which can be easily seen without any wash out or colors mix.

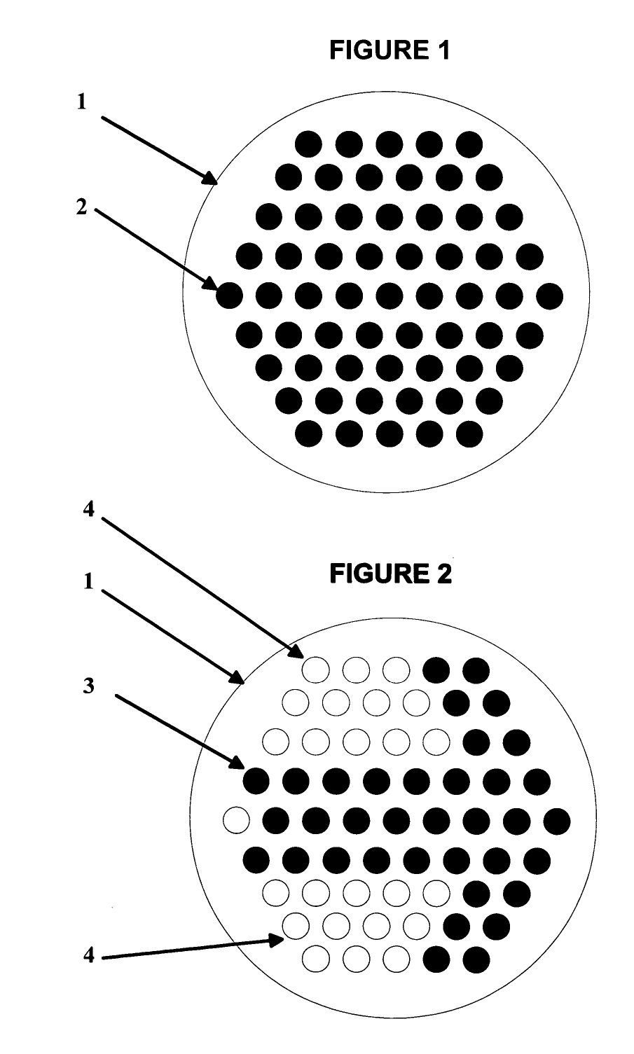

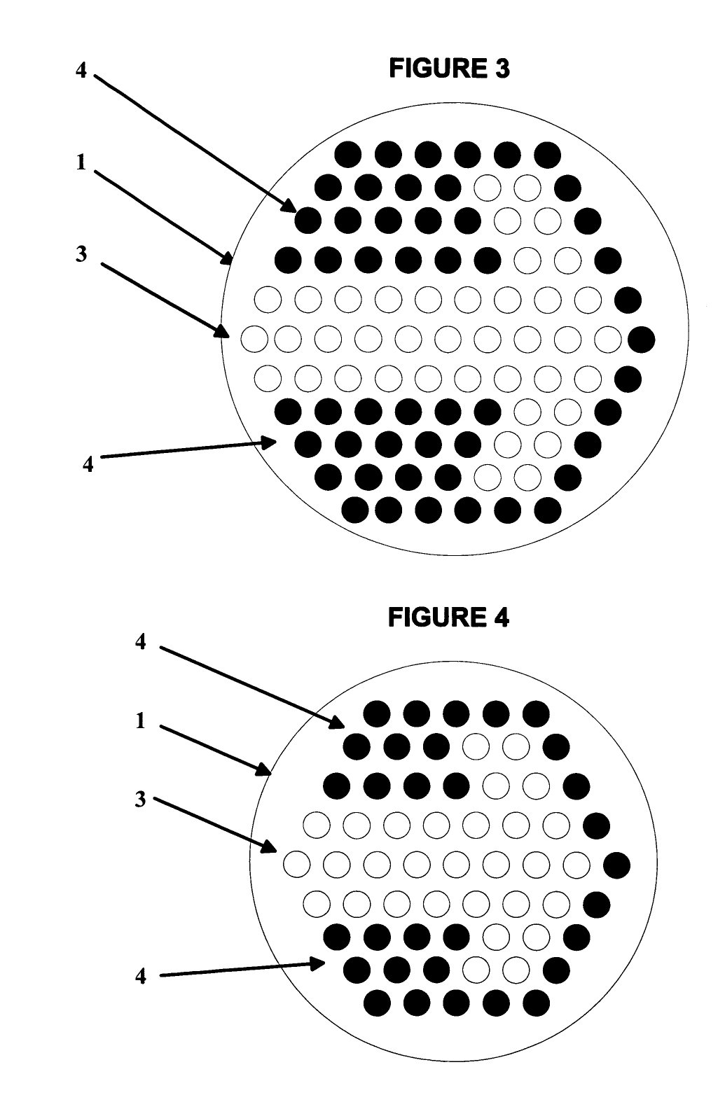

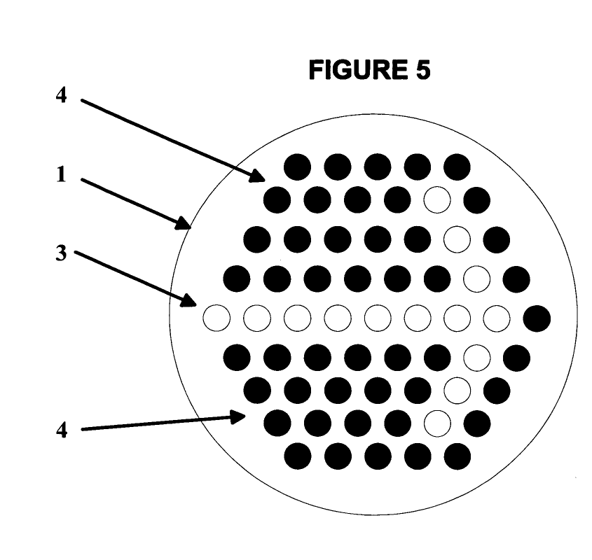

### DETAILED DESCRIPTION OF THE INVENTION

An LED Light for vehicle usage that is a combination of running light, turn signal light and can also include running light/brake light/turn combination all contained in one signal light housing. The running light, brake light/ turn light can contain all the same color LEDs and when the turn arrow with red or amber LEDs is turn ON for turn mode the other LEDs not part of the arrow pattern are then turn off. The same light can also use two different colors of LEDs or chip inside the same LED that can create a changing pattern from the red running light/brake light to an arrow light in red amber. The same light can also have the same color LEDs for running light and stop/turn light and where the arrow shape LEDs are canceled, turned OFF from running or brake light mode to an outlined arrow when the turn signal is activated for turn signal mode adding to better visibility and direction to motorist of what the vehicle is doing without having to use more than one lamp per side..

What is claimed is:

1. Any led light of any size or configuration that contains any number of LEDs that are used in vehicles for running light or brake light that will look like any size or shape arrow when place in turn signal mode, all contained a single light housing.

2. Any vehicle led light of any size or configuration that contains any number of LEDs that are used for running light, brake light and turn signal that will look like a red arrow when placed in turn signal mode all contained a single light housing.

3. Any vehicle led light of any size or configuration that contains any number of LEDs that are used for running light, brake light and turn signal that will look like an amber arrow when placed in turn signal mode all contained a single light housing.
